(19) United States
(12) Patent Application Publication
(10) Pub. No.: US 2025/0383108 A1
(43) Pub. Date: Dec. 18, 2025

(54) SYSTEM AND METHOD FOR CONTROLLING A FLOW UNIT

(71) Applicant: Siemens Industry, Inc., Alpharetta, GA (US)

(72) Inventors: Ryan Soo, Chicago, IL (US); Gregory Kempf, Silver Lake, WI (US)

(73) Assignee: Siemens Industry, Inc., Alpharetta, GA (US)

(21) Appl. No.: 18/742,661

(22) Filed: Jun. 13, 2024

(51) Int. Cl. F24F 11/49; F24F 11/63; F24F 11/74; F24F 110/40

(52) U.S. Cl. CPC F24F 11/49; F24F 11/63; F24F 11/74; F24F 2110/40

(57) ABSTRACT

There is described a controller and method for controlling a flow unit. The controller detects calibration pressure drops of the flow unit, calibration flows of the flow unit, and calibration positions of the flow control element corresponding to the calibration pressure drops and the calibration flows. The controller establishes first calibrations of the flow unit based on the calibration pressure drops and second calibrations of the flow unit based on the calibration flows. The controller detects an operation pressure drop and an operation position of the flow control element. The operation position of the flow control element is controlled based on the operation pressure drop, a particular one of the first calibrations corresponding to the operation position, and a particular one of the second calibrations corresponding to the operation position.

### RELATED APPLICATIONS

This application is related to U.S. patent application Ser. No. 17/710,240, titled Controller and Method for Managing a Flow Unit, by Ryan Soo and Gregory Kempf, filed on Mar. 31, 2022; and U.S. patent application Ser. No. 18/476,806, titled Controller and Method for Managing a Flow Unit, by Ryan Soo, filed on Sep. 28, 2023; both of which are incorporated by reference in their entirety.

### FIELD OF THE INVENTION

This application relates to the field of controllers for flow units and, more particularly, to a system and method for controlling a flow control element of a flow unit.

### BACKGROUND

Building automation systems encompass a wide variety of building devices that aid in the monitoring and control of various aspects of building operation. Building devices managed by a building automation system include security units, fire safety units, lighting units, and heating, ventilation, and air conditioning (“HVAC”) unit. For example, the system may manage many building devices of an HVAC unit dispersed about a facility by co-locating and coupling a controller of the building automation system with the devices.

Airflow of an HVAC unit is typically calculated from a duct velocity pressure measurement based on the difference between static pressure and total pressure. A differential pressure transducer is used to measure the duct velocity pressure. Traditionally, minimum airflow setpoints have been limited to values based on the limitations of the differential pressure transducer. Advances in differential pressure transducer technology have allowed for the minimum duct velocity to be lower.

Air valves may operate a single or dual blade damper based on measured values. The measured values may include the total pressure and a sub-static pressure on the downstream side of the damper along with an accurate measurement of one or more damper positions. The air valve is placed in a calibrated airflow system and the air valve's airflow is characterized based on the total pressure/sub-static pressure and the damper positions.

### SUMMARY

In accordance with one embodiment of the disclosure, there is provided a system and method for controlling a flow control element of a flow unit. Conventional products require a special damper assembly with an actuator that has a highly accurate feedback signal. The airflow calculation for these damper assemblies must be characterized when installed in a calibrated airflow test system. The system operable to employ the techniques described herein may be applied to single blade damper assemblies, allowing for lower cost retrofit options. Sheetmetal work and electrical work are minimized, and special damper actuators are not required. A field calibration sequence is executed for each damper assembly. This negates any differences between the position feedback signals from different actuators.

One aspect is a controller for managing a flow unit comprising an input component, a processor, and an output component. The input component detects calibration pressure drops of the flow unit, calibration flows of the flow unit, and calibration positions of the flow control element corresponding to the calibration pressure drops and the calibration flows. The input component also detects an operation pressure drop and an operation position of the flow control element. The processor establishes first calibrations of the flow unit based on the calibration pressure drops and second calibrations of the flow unit based on the calibration flows. The output component controls the operation position of the flow control element based on the operation pressure drop, a first calibration of the first calibrations corresponding to the operation position, and a second calibration of the second calibrations corresponding to the operation position.

Another aspect is a method of a controller for managing a flow unit. Calibration pressure drops of the flow unit, calibration flows of the flow unit, and calibration positions of the flow control element corresponding to the calibration pressure drops and the calibration flows are detected. First calibrations of the flow unit based on the calibration pressure drops and second calibrations of the flow unit based on the calibration flows are established. An operation pressure drop and an operation position of the flow control element are detected. The operation position of the flow control element is controlled based on the operation pressure drop, a first calibration of the first calibrations corresponding to the operation position, and a second calibration of the second calibrations corresponding to the operation position.

Yet another aspect is a non-transitory computer readable medium including executable instructions which, when executed, causes at least one processor to manage a flow unit by the method described above.

The above-described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 is an illustration of a building automation system in an example implementation that is operable to employ techniques described herein.

FIG. 2 is a block diagram of a controller in an example implementation which is part of the building automation system of FIG. 1.

FIG. 3 depicts a simplified heating, ventilation, and air conditioning (“HVAC”) unit in an example implementation that is managed by the building automation system of FIG. 1.

FIG. 4 is a flow diagram depicting calibration and operation of a controller for a flow unit in an example implementation that is operable to employ techniques described herein.

### DETAILED DESCRIPTION

Various technologies that pertain to systems and methods that facilitate control of a flow control element of a flow unit will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

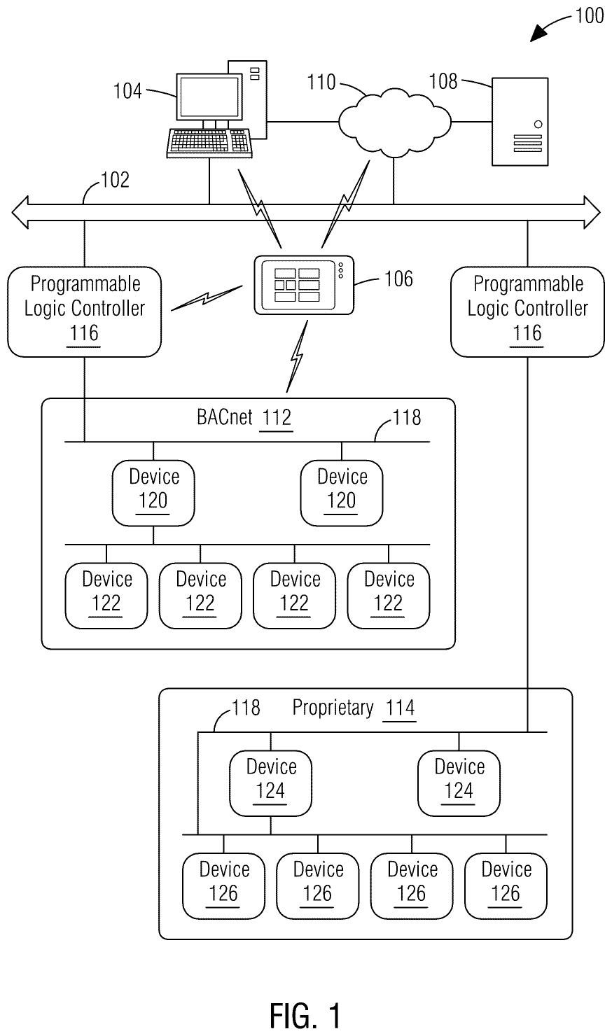

Referring to FIG. 1, there is shown a building automation system (“BAS”) 100 in an example implementation that is operable to employ techniques described herein. The BAS 100 includes an environmental control system configured to control one or more environmental parameters for a facility, such as airflow, air pressure, air temperature, fluid flow, fluid pressure, fluid temperature, and the like. For example, the BAS 100 may comprise one or more network connections or primary buses 102 for connectivity to components of a management level network (“MLN”) of the system. For one embodiment, the example BAS 100 may comprise one or more management level devices or management devices, such as a management workstation 104, a mobile device 106, or a remote management device 108 connecting through a wired or wireless network 110, that allows the setting and/or changing of various controls of the system. For example, a management device may be a mobile device connecting through a wired or wireless link to an individual automation or field level device, such as a controller 120-126, that allows the setting and/or changing of various controls of the device. While a brief description of the BAS 100 is provided below, it will be understood that the BAS 100 described herein is only one example of a particular form or configuration for a BAS. The system 100 may be implemented in any other suitable manner without departing from the scope of this disclosure. The management devices are configured to provide overall control and monitoring of automation devices, field devices, and other controllers of the BAS 100.

For the illustrated embodiment of FIG. 1, the BAS 100 provides connectivity based on one or more communication protocols to subsystems for various environmental parameters, such as components of environmental comfort systems. Each subsystem 112, 114 may include various automation level devices 120, 124 (“automation controllers”) for monitoring and controller field devices as well as various field level devices 122, 126 (“field controllers”) for monitoring and controlling areas within a building or group of buildings. For field controllers 122, 126 that monitor and control air and/or fluid heating-cooling HVAC equipment, the field controllers may include, but are not limited to, actuators, sensors, and other types of controllers for the HVAC equipment, such as heating/cooling generators, fans, dampers, filters, pumps, compressors, condensers, evaporators, tanks/reservoirs, valves, bypass mechanisms, and the like.

For some embodiments, the BAS 100 may include one or more programmable logic controllers 116 for connectivity to components of a building level network (BLN) of the system 100. Each programmable logic controller 116 may connect the primary bus 102 of the MLN to a secondary bus 118 of the BLN. Each programmable logic controller 116 may also include management logic for switching, power quality, and distribution control for the BLN components. For example, automation controllers 120, 122 may communicate directly with the network connection or secondary bus 118 of the BLN, whereas field controllers 124, 126 may communicate through, and controlled by, the automation controllers.

In these illustrative embodiments, objects associated with the BAS 100 include data created, processed, and stored by the automation controllers 120, 124 and the field controllers 122, 126, such as temperature data, pressure data, and air/fluid flow, as well as analytical data, such as control schedules, trend reports, defined system hierarchies, and the like. The illustration of the BAS 100 in FIG. 1 is not meant to imply physical or architectural limitations to the manner in which different illustrative embodiments may be implemented. Other components in addition to and/or in place of the ones illustrated may be used, and some components may be unnecessary in some illustrative embodiments.

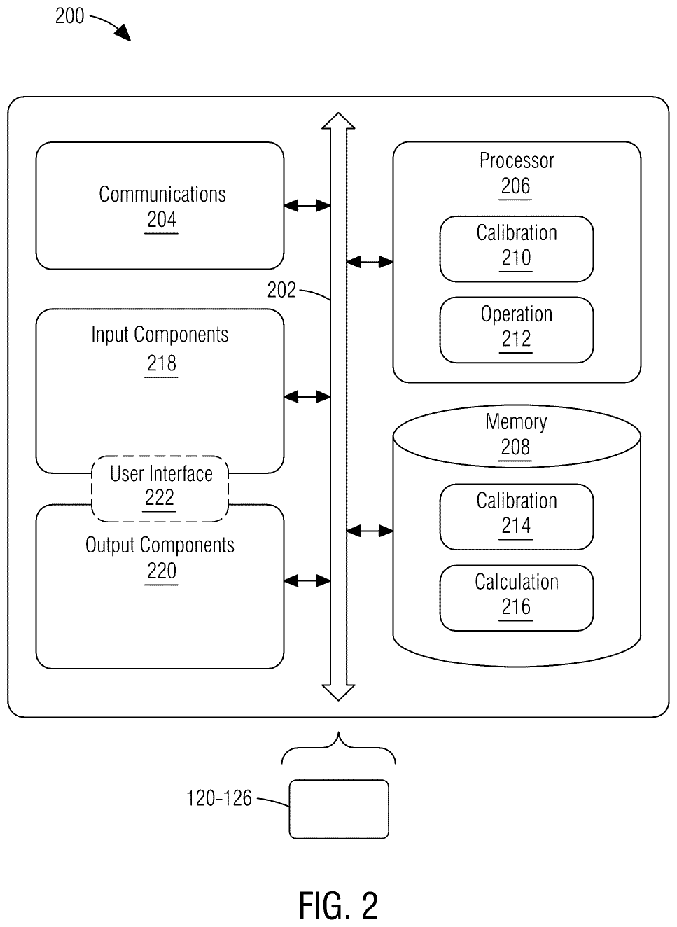

FIG. 2 represents example device components 200 of one or more controllers 120-126 of the building automation system 100, described above in reference to FIG. 1, in an example implementation. The device components 200 comprise a communication bus 202 for interconnecting other device components directly or indirectly. The other device components include one or more communication components 204 communicating with other entities via a wired or wireless network, one or more processors 206, and one or more memory components 208.

The communication component 204 communicates (i.e., receives and/or transmits) data associated with one or more devices of the system 100, such as another controller 120-126 or a management device 104-108. The communication component 204 may utilize wired technology for communication, such as transmission of data over a physical conduit, e.g., an electrical or optical fiber medium. The communication component 204 may also utilize wireless technology for communication, such as radio frequency (RF), infrared, microwave, light wave, and acoustic communications. RF communications include, but are not limited to, Bluetooth (including BLE), ultrawide band (UWB), Wi-Fi (including Wi-Fi Direct), Zigbee, cellular, satellite, mesh networks, PAN, WPAN, WAN, near-field communications, and other types of radio communications and their variants.

The processor or processors 206 may execute code and process data received from other components of the device components 200, such as information received at the communication component 204 or stored at the memory component 208. The code associated with the controller 120-126 and stored by the memory component 208 may include, but is not limited to, operating systems, applications, modules, drivers, and the like. An operating system includes executable code that controls basic functions, such as interactions among the various components of the device components 200, communication with external devices via the communication component 204, and storage and retrieval of code and data to and from the memory component 208.

Each application includes executable code to provide specific functionality for the processor 206 and/or remaining components of the controller 120-126. Examples of applications executable by the processor 206 include, but are not limited to, a calibration module 210 and an operation module 212. The calibration module 210 establishes first calibrations of the flow unit based on calibration pressure drops and second calibrations of the flow unit based on calibration flows. The operation module 212 controls the operation position of the flow control element based on an operation pressure drop, a particular first calibration corresponding to the operation position, and a particular second calibration corresponding to the operation position.

Data stored at the memory component 208 is information that may be referenced and/or manipulated by an operating system or application for performing functions of the controller 120-126. Examples of data associated with the controller 120-126 and stored by the memory component 208 may include, but are not limited to, calibration data 214 and calculation 216. Examples of the calibration data 214 include calibration pressure drops, calibration flows, calibration positions of the flow control unit, first calibrations of the flow unit, and second calibration of the flow unit. Examples of the calculation data 216 include an operation pressure drop, an operation position of the flow control unit, and signals or messages for controlling the operation position of the flow control element.

The device components 200 may include one or more input components 218 and one or more output components 220. One or more input components 218 detect a measured full flow and pressure drop corresponding to a full open position of a flow control element of the flow unit that is controlled by the controller 120-126. The one or more input components 218 also detect an operation measured flow and operation pressure drop of the flow unit and an operation position of the flow control element. One or more output components 220 control the operation position of the flow control element based on the operation relative flow and the relative flow setpoint.

The input components 218 and output components 220 of the device components 200 may also include one or more visual, audio, mechanical, and/or other components. For some embodiments, the input and output components 218, 220 may include a user interface 222 for interaction with a user of the device. The user interface 222 may include a combination of hardware and software to provide a user with a desired user experience.

It is to be understood that FIG. 2 is provided for illustrative purposes only to represent examples of the controller 120-126 and is not intended to be a complete diagram of the various components that may be utilized by the system 100. Therefore, the controller 120-126 may include various other components not shown in FIG. 2, may include a combination of two or more components, or a division of a particular component into two or more separate components, and still be within the scope of the present invention.

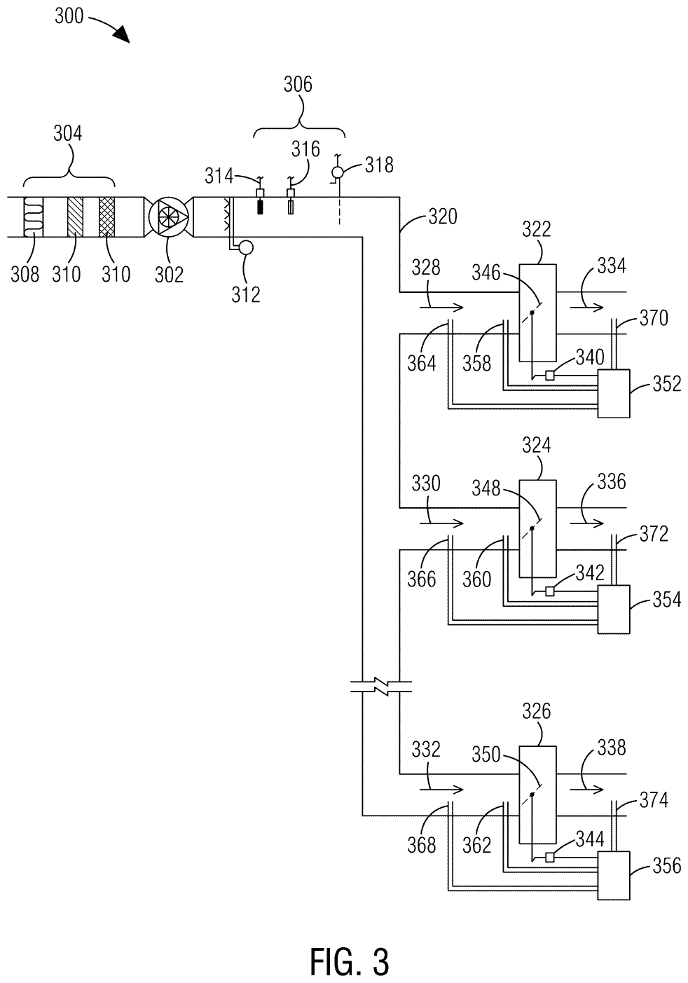

Referring to FIG. 3, there is shown a simplified environmental control unit 300, such as a heating, ventilation, and air conditioning (“HVAC”), in an example implementation that may be managed by the building automation system. Although the environmental control unit 300 is shown in FIG. 3 as an HVAC unit by example, it is to be understood that the techniques described herein may be applied to flow devices of a building automation system that manage the flow of a variety of mediums including gas and liquid. For example, any reference to airflow throughout this disclosure may also apply to fluid flow and vice versa. Similarly, reference to fans may also apply to pumps, and so on.

The controllers, methods, and media employ the techniques described herein to calibrate and operate each flow unit of the environmental control unit 300 to accommodate, or compensate for, modulation changes to the maximum flow through any of the flow units. The environmental control unit 300 includes a flow source 302 such as a fan or pump. For some embodiments, the environmental control unit 300 also includes upstream components 304 positioned upstream from the flow source and/or downstream components position 306 downstream from the flow source. Examples of components that may be positioned upstream and/or downstream of the flow source 302 include, but are not limited to filters 308, heating and/or cooling coils 310, humidifiers 312, and sensors 314-318. The sensors may include a pressure sensor 318 (also known as a pressure transmitter) to operate the flow source 302 so that it maintains the pressure sensor to a desired setpoint. In this manner, as the setpoint of the pressure sensor 318 is modulated, the speed of the flow source 302 changes the performance of other devices along the pipe or duct 320 downstream from the flow source. The controllers, methods, and media optimize the performance of flow devices downstream from the flow source in view of these modulation changes to the maximum flow.

The environmental control unit 300 further includes multiple flow units 322-326, positioned downstream from the flow source 302. Each flow unit includes a flow inlet 328-332 and a flow outlet 334-338, and each flow unit is associated with a maximum flow rate and a minimum flow rate. For example, a first flow unit 322 may have a maximum flow rate of 1100 CFM and a minimum flow rate of 175 CFM. Where the flow rate of the first flow unit 322 changes from 175 to 1100, the flow from the flow source 302 through the pipe or duct 320 to the first terminal unit 322 increases. The increase in total flow of the flow unit 322-326 increases any pressure drop along the pipe or duct 320 between the flow source 302 and the rest of the system, i.e., the environmental control unit 300. As the pressure changes at the inlet 328-332 of each flow unit 322-326, the maximum amount of flow that may be achieved when the flow unit is at full open changes.

The environmental control unit 300 includes controllers 352-356 to manage the calibration and operation of the flow units 322-326. In particular, each flow unit 322-326 includes a flow control element 346-350, such as an air damper or a fluid valve, which is controlled by a corresponding controller 352-356. For example, the environmental control unit 300 may include an actuator 340-344 for each flow unit 322-326 that is managed by a corresponding controller 352-356 and controls a corresponding flow control element 346-350. Thus, the controllers 352-356 of the building automation system control flow control element 346-350 of the environmental control unit 300.

The building automation system may also include flow sensors 358-362 that provide flow sensor data to the corresponding controller 352-356. The building automation system may further include pre-unit pressure sensors 364-368 and post-unit pressure sensors 370-374. The pressure sensors 364-370 detect pressure measurements from static pressure probes positioned in the flow path across the flow control element 346-350, determines a differential pressure based on the pressure measurements of the post-unit pressure sensors 370-374 and the pre-unit pressure sensors 364-368, and provides a signal to the controller 352-356 representing the differential pressure. For example, the pressure sensors 364-370 may include pre-unit and post-unit probes in the flow path and coupled to a differential pressure transducer, which sends a differential pressure signal based on the pressure measurements of the probes to the controller 352-356.

Each controller 352-356 manages the corresponding flow control element 346-350 by modulating its output to drive the corresponding the actuator 340-344 and to control setpoints for the sensors 358-374. The pressure sensors 364-374 are more effective than the flow sensors 358-362 for measurements taken when the flow control element 346-350 is closer to being in the closed position. The flow sensors 358-362 are more effective than the pressure sensors 364-374 for measurements taken when the flow control element 346-350 is closer to being in the opened position. Thus, utilization of both types of sensors, i.e., the flow sensors 358-362 and the pressure sensors 364-374, allows for optimal measurements of dynamic nominal for any and/or all positions of the flow control elements 346-350.

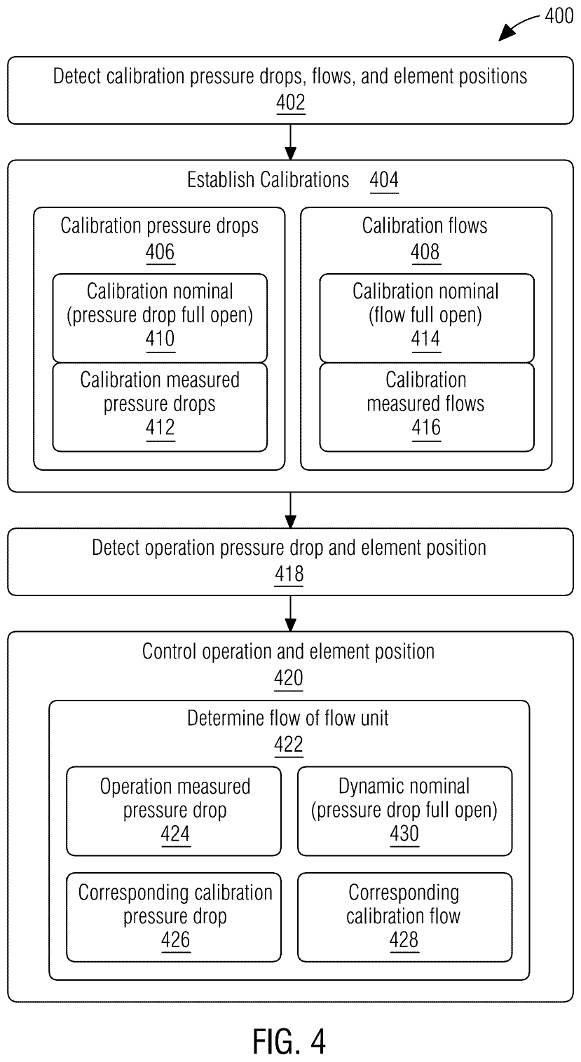

Referring to FIG. 4, there is shown a flow diagram depicting calibration and operation processes 400 of a controller 120-126, 340-344 for a flow unit 322-326. Specifically, the processes 400 include calibrating the controller of the flow unit and operating the controller of the flow unit subsequent to calibrating the controller.

The controller 340-344 (also 120-126 of FIG. 1) for a flow unit 322-326 is calibrated by detecting (402) sensor data of the flow unit and establishing calibrations of the flow unit based on the sensor data. In particular, the controller 340-344 detects (402) calibration pressure drops of the flow unit, calibration flows of the flow unit, and calibration positions of the flow control element. The calibration positions of the flow control element correspond to the calibration pressure drops and the calibration flows. The controller 340-344 establishes (404) first calibrations of the flow unit based on the calibration pressure drops (406), and the controller establishes second calibrations of the flow unit based on the calibration flows (408).

For some embodiments, the controller 340-344 may establish (404) the first calibrations (406) based on a first calibration nominal (410) and the calibration pressure drops (412) corresponding to the different calibration positions of the flow control element. Likewise, the controller 340-344 may establish (404) the second calibrations (408) based on a second calibration nominal (414) and the calibration flows (416) corresponding to the different calibration positions of the flow control element. The first calibration nominal (410) may be based on a measured pressure drop across the flow control element at a maximum open position. The second calibration nominal (414) may be based on a measured flow across the flow control element at the maximum open position.

For some embodiments, a table may be generated based on inputs into one or more functions. The inputs may include the position of the flow control element, the measured pressure loss across the control element, and the measured flow. For the table, the nominal value (e.g. nominal airflow) and the flow of the flow unit may be calculated. A first calibration nominal (410) may be established based on the measured pressure drop corresponding to a fully open position of the control element of the flow unit. Calibration relative pressure drops (412) may be calculated based on the calibration pressure drop at full open and calibration measured pressure drops corresponding to calibration positions of the flow control element. A second calibration nominal (414) may be established based on the measured flow corresponding to a fully open position of the control element of the flow unit. Calibration relative flows (416) may be calculated based on the calibration flow at full open and calibration measured flows corresponding to calibration positions of the flow control element.

Referring to the above embodiments, an example of a table may be represented as follows:

| Position (Open) | Relative Pressure Drop | Relative Flow |
|---|---|---|
| 100% | P0 | QRel0 |
| X1 | P1 | QRel1 |
| . . . | . . . | . . . |
| Xn | Pn | QReln |

Subsequent to calibrating (404) the controller 340-344, the controller operates by detecting (418) operation measured pressure drop of the flow unit and an operation position of the flow control element. The controller 340-344 detects the operation pressure drop and the operation position of the flow control element subsequent to establishing (404) the first and second calibrations (406, 408).

In response to detecting (418) the operation measured pressure drop and the operation position, the controller 340-344 then controls (420) the operation of the flow control element. In order to control (420) the operation of the flow control element, the controller 340-344 determines (422) a flow of the flow unit. In this manner, the controller 340-344 controls (420) the operation of the flow control element based on the operation measured pressure drop (424), a first calibration (426) corresponding to the operation position, and a second calibration (428) corresponding to the operation position. The first calibration corresponding to the operation position is one of the plurality of first calibrations (406) established (404) during the calibration portion of the process 400. Likewise, the second calibration corresponding to the operation position is one of the plurality of second calibrations (408) established (404) during the calibration portion of the process 400. The controller 340-344 determines (422) the flow of the flow unit based on the first calibration (426), the second calibration (428), and a dynamic nominal (430). The dynamic nominal (430) may be determined based on a square root of the dynamic pressure drop at full open, as represented by the following formula:

$${Q}_{nominal} = k \sqrt{{P}_{o p e n}} \qquad ( a )$$

As indicated by this formula, the dynamic nominal (Qₙₒₘᵢₙₐₗ) (430) may be calculated using a coefficient (k) multiplied by the square root of the dynamic pressure drop at full open (Pₒₚₑₙ). Accordingly, the controller 340-344 determines the dynamic pressure drop at full open based on the operation pressure drop and a particular calibration pressure drop of the first calibrations corresponding to the operation position of the flow control element.

In response to determining the dynamic nominal (430), the controller 340-344 may determine a calibration relative flow based on the operation position of the flow control element. The calibration relative flow based on the operation position may be determined as one of the plurality of calibration relative flows (416), such as the second calibrations (408), established (404) during the calibration portion of the process 400. The flow of the flow unit may be calculated by multiplying the dynamic nominal by the calibration relative flow, as represented by the following:

$$Q = {Q}_{nominal} * {Q}_{R e {l}_{c a l}} \qquad ( b )$$

Those skilled in the art will recognize that, for simplicity and clarity, the full structure and operation of all data processing systems suitable for use with the present disclosure are not being depicted or described herein. Also, none of the various features or processes described herein should be considered essential to any or all embodiments, except as described herein. Various features may be omitted or duplicated in various embodiments. Various processes described may be omitted, repeated, performed sequentially, concurrently, or in a different order. Various features and processes described herein can be combined in still other embodiments as may be described in the claims.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an example embodiment of the present disclosure has been described in detail, those skilled in the art will understand that various changes, substitutions, variations, and improvements disclosed herein may be made without departing from the spirit and scope of the disclosure in its broadest form.

What is claimed is:

1. A controller for managing a flow unit comprising:
an input component configured to detect a plurality of calibration pressure drops of the flow unit, a plurality of calibration flows of the flow unit, and a plurality of calibration positions of the flow control element corresponding to the plurality of calibration pressure drops and the plurality of calibration flows, the input component being further configured to detect an operation pressure drop and an operation position of the flow control element;
a processor configured to establish a first plurality of calibrations of the flow unit based on the plurality of calibration pressure drops and a second plurality of calibrations of the flow unit based on the plurality of calibration flows; and
an output component configured to control the operation position of the flow control element based on the operation pressure drop, a first calibration of the first plurality of calibrations corresponding to the operation position, and a second calibration of the second plurality of calibrations corresponding to the operation position.

2. The controller as described in claim 1, wherein:
the processor establishes the first plurality of calibrations based on a first calibration nominal and the plurality of calibration pressure drops corresponding to the plurality of different calibration positions of the flow control element, the first calibration nominal being based on a measured pressure drop across the flow control element at a maximum open position; and
the processor establishes the second plurality of calibrations based on a second calibration nominal and the plurality of calibration flows corresponding to the plurality of different calibration positions of the flow control element, the second calibration nominal being based on a measured flow across the flow control element at the maximum open position.

3. The controller as described in claim 1, wherein the input component detects the operation pressure drop and the operation position of the flow control element subsequent to the processor establishing the first and second pluralities of calibrations.

4. The controller as described in claim 1, wherein the processor determines a dynamic pressure drop at full open based on the operation pressure drop and a particular calibration pressure drop of the first plurality of calibrations corresponding to the operation position of the flow control element.

5. The controller as described in claim 4, wherein the processor determines a flow of the flow unit based on the first calibration, the second calibration, and a dynamic nominal.

6. The controller as described in claim 5, wherein the processor determines the dynamic nominal based on a square root of the dynamic pressure drop at full open.

7. A method of a controller for managing a flow unit, the method comprising:
detecting a plurality of calibration pressure drops of the flow unit, a plurality of calibration flows of the flow unit, and a plurality of calibration positions of the flow control element corresponding to the plurality of calibration pressure drops and the plurality of calibration flows;
establishing a first plurality of calibrations of the flow unit based on the plurality of calibration pressure drops and a second plurality of calibrations of the flow unit based on the plurality of calibration flows;
detecting an operation pressure drop and an operation position of the flow control element; and
controlling the operation position of the flow control element based on the operation pressure drop, a first calibration of the first plurality of calibrations corresponding to the operation position, and a second calibration of the second plurality of calibrations corresponding to the operation position.

8. The method as described in claim 7, wherein establishing the first and second pluralities of calibrations comprises:
establishing the first plurality of calibrations based on a first calibration nominal and the plurality of calibration pressure drops corresponding to the plurality of different calibration positions of the flow control element, the first calibration nominal being based on a measured pressure drop across the flow control element at a maximum open position; and
establishing the second plurality of calibrations based on a second calibration nominal and the plurality of calibration flows corresponding to the plurality of different calibration positions of the flow control element, the second calibration nominal being based on a measured flow across the flow control element at the maximum open position.

9. The method as described in claim 7, wherein detecting the operation pressure drop and the operation position of the flow control element includes detecting the operation pressure drop and the operation position of the flow control element subsequent to establishing the first and second pluralities of calibrations.

10. The method as described in claim 7, further comprising determining a dynamic pressure drop at full open based on the operation pressure drop and a particular calibration pressure drop of the first plurality of calibrations corresponding to the operation position of the flow control element.

11. The method as described in claim 10, further comprising determining a flow of the flow unit based on the first calibration, the second calibration, and a dynamic nominal.

12. The method as described in claim 11, further comprising determining the dynamic nominal based on a square root of the dynamic pressure drop at full open.

13. A non-transitory computer readable medium including executable instructions which, when executed, causes at least one processor to manage a flow unit by:
detecting a plurality of calibration pressure drops of the flow unit, a plurality of calibration flows of the flow unit, and a plurality of calibration positions of the flow control element corresponding to the plurality of calibration pressure drops and the plurality of calibration flows;
establishing a first plurality of calibrations of the flow unit based on the plurality of calibration pressure drops and a second plurality of calibrations of the flow unit based on the plurality of calibration flows;
detecting an operation pressure drop and an operation position of the flow control element; and
controlling the operation position of the flow control element based on the operation pressure drop, a first calibration of the first plurality of calibrations corresponding to the operation position, and a second calibration of the second plurality of calibrations corresponding to the operation position.

14. The non-transitory computer readable medium as described in claim 13, wherein establishing the first and second pluralities of calibrations comprises:
establishing the first plurality of calibrations based on a first calibration nominal and the plurality of calibration pressure drops corresponding to the plurality of different calibration positions of the flow control element, the first calibration nominal being based on a measured pressure drop across the flow control element at a maximum open position; and
establishing the second plurality of calibrations based on a second calibration nominal and the plurality of calibration flows corresponding to the plurality of different calibration positions of the flow control element, the second calibration nominal being based on a measured flow across the flow control element at the maximum open position.

15. The non-transitory computer readable medium as described in claim 13, wherein detecting the operation pressure drop and the operation position of the flow control element includes detecting the operation pressure drop and the operation position of the flow control element subsequent to establishing the first and second pluralities of calibrations.

16. The non-transitory computer readable medium as described in claim 13, further comprising determining a dynamic pressure drop at full open based on the operation pressure drop and a particular calibration pressure drop of the first plurality of calibrations corresponding to the operation position of the flow control element.

17. The non-transitory computer readable medium as described in claim 16, further comprising determining a flow of the flow unit based on the first calibration, the second calibration, and a dynamic nominal.

18. The non-transitory computer readable medium as described in claim 17, further comprising determining the dynamic nominal based on a square root of the dynamic pressure drop at full open.
